(19) United States
(12) Patent Application Publication
(10) Pub. No.: US 2009/0222760 A1
(43) Pub. Date: Sep. 3, 2009

(54) Method, System and Computer Program Product for Automating the Selection and Ordering of Column Data in a Table for a User

(76) Inventors: Steven G. Halverson, Rochester, MN (US); Gregory R. Hintermeister, Rochester, MN (US)

Correspondence Address: IBM CORPORATION, 3605 HIGHWAY 52 NORTH, DEPT 917, ROCHESTER, MN, 55901-7829, US

(21) Appl. No.: 12/039,899

(22) Filed: Feb. 29, 2008

(51) Int. Cl. G06F 3/048

(52) U.S. Cl. 715/781

(57) ABSTRACT

A method, system, and computer program product for automating the selection and ordering of column data in a table for a user are presented. In an exemplary manner, when a selected column is received, at least one available column related to the selected column is automatically recommended for display in an active table view. In response to the selected column being placed in the automatic data manipulation mode, a manipulation relationship between the selected column and the available column(s) is identified. When the selected column is manipulated (e.g., sorted, filtered), the available column(s) related to the selected column are automatically manipulated. The related available column(s) that are automatically recommended are concurrently displayed and grouped with the selected column in an active table view. Moreover, if a sort relationship exists between the available column(s) and the manipulated selected column, the related available column(s) are displayed according to the sort relationship.

### BACKGROUND OF THE INVENTION

The present disclosure relates to database management systems, and specifically to display tools relating to column data selection and ordering.

Computer users are increasingly taking advantage of user interfaces for presenting data in a tabular format. Most of these user interfaces allow the user to customize columns of data. Typically, such customization is performed by presenting the user with a list of available columns, as well as a list of currently selected columns. To save available display real estate, the available and/or selected column data are represented by their respective column header/names. When presented with both selected and available lists, the user is given the opportunity to select and move column headers listed from the available column list for inclusion in the currently selected column list, and vice versa. As each column header is selected from the available list, the column header is appended to the bottom of the selected column list. The user can then manually manipulate the ordering of the selected column headers listed for eventual display of the column data in an active table view.

However, the above described process of selecting the type and the display order of column data for display is not a very efficient process for the user. First, the user has to manually parse through the entire available column list to determine whether any of the available columns (i.e., also referred to as available column data) should be grouped with currently selected columns (i.e., also referred to as selected column data). In this regard, it is important to consider that an available column list can have an unwieldy number of available column headers depending on the size of the database. Second, due to the complexity of the database, a user may have a difficult time identifying potential available column(s) to be grouped in the same table. Moreover, even if a user can successfully identify available column data for inclusion, it may still not be obvious to the user to (i) position the available column data next to a related column and/or (ii) manipulate (i.e., sort, filter, and the like) the data within a chosen available column relative to the data in other selected column(s) for a more effective presentation of the tabular data. These difficulties can arise not only by the selection of available columns, but also by the active manipulation of selected column data.

### BRIEF SUMMARY OF THE INVENTION

In view of the foregoing, a method, system, and computer program product for automating the selection and ordering of column data in a table for a user are disclosed. The method includes receiving a selected column data for display in an active table view. In response to receiving the selected column data, at least one available column data related to the selected column data is automatically recommended for display in the active table view. The selected column data is placed in an automatic data manipulation mode. In response to the placement of the selected column data in the automatic data manipulation mode, a manipulation relationship between the selected column data and one or more available column data related to the selected column data is identified. In the automatic data manipulation mode, the selected column data is manipulated. The manipulation of the selected column data is an initial column action that includes at least one of an initial column data sort or an initial column data filter. In response to the initial column data sort of the selected column data, the one or more available column data related to the selected column data are automatically manipulated. The automatic manipulating step of the one or more available column data is a subsequent column action including at least one of a subsequent column data sort or a subsequent column data filter. The selected column data and the one or more available column data related to the selected column data are concurrently displayed in the active table view. In this regard, the selected column data is in an initial column data manipulation view and the one or more available column data related to the selected column data is in a subsequent column data manipulation view.

All objects, features, and advantages of the present invention will become apparent in the following detailed written description.

### BRIEF DESCRIPTION OF THE SEVERAL VIEWS OF THE DRAWINGS

Aspects of the invention itself will best be understood by reference to the following detailed description of an illustrative embodiment when read in conjunction with the accompanying drawings, where:

FIG. 1 depicts an exemplary computer in which the present invention may be implemented;

FIG. 2 is a high-level flow-chart of exemplary steps taken by the present invention to automate the selection and ordering of column data in a table for a user, according to an embodiment of the present invention;

FIG. 3 depicts an exemplary data table;

FIGS. 4A and 4B are graphical representations of an exemplary display screenshot showing a column with a smart column chooser mode enabled and an automatic sort of available columns mode disabled, according to an embodiment of the present invention; and

FIGS. 5A and 5B are graphical representations of an exemplary display screenshot showing a column with a smart column chooser mode enabled and an automatic sort of available columns mode enabled, according to an embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java® (JAVA is a trademark or registered trademark of Sun Microsystems, Inc. in the United States and other countries), Smalltalk® (SMALLTALK is a trademark or registered trademark of Cincom Systems, Inc.), C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

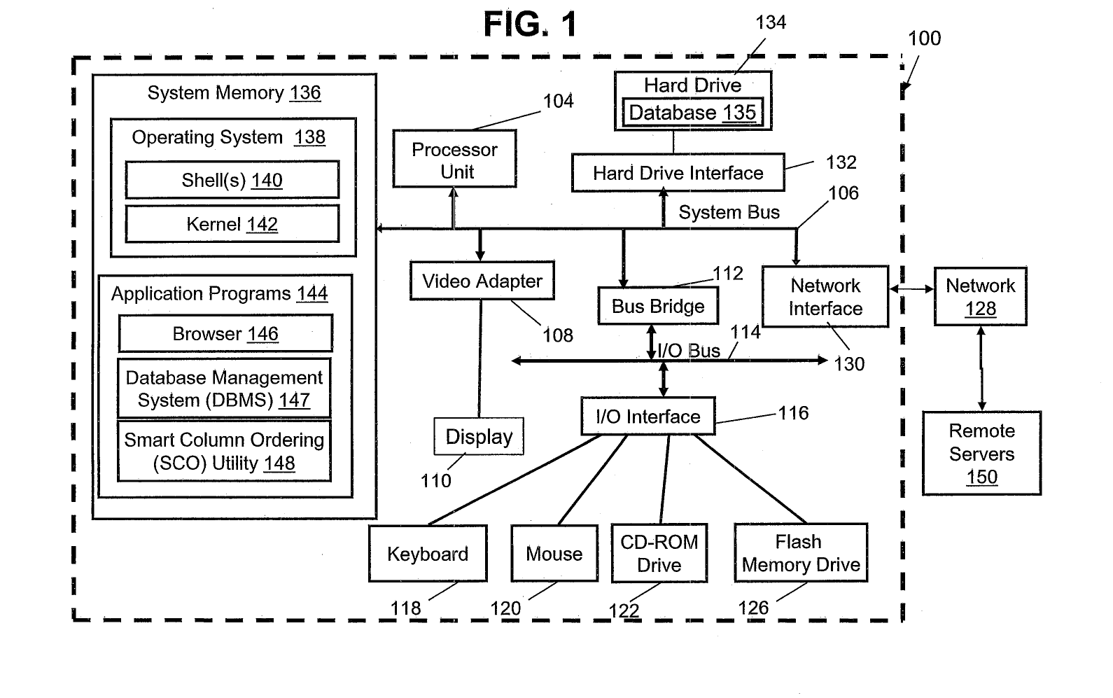

With reference now to the figures, and in particular to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a remote server 150 via a network 128 using a network interface 130, which is coupled to system bus 106. Network 128 may be an external network such as the Internet, or an internal network such as an Ethernet or a Virtual Private Network (VPN). Remote server 150 may be architecturally configured in the manner depicted for computer 100.

A hard drive interface 132 is also coupled to system bus 106. Hard drive interface 132 interfaces with a hard drive 134. In one embodiment, hard drive 134 populates a system memory 136, which is also coupled to system bus 106. Hard drive 134 may include a database 135, which contains at least one data table which can be broken down into rows and columns. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX® (UNIX is a registered trademark of The Open Group in the United States and other countries)) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

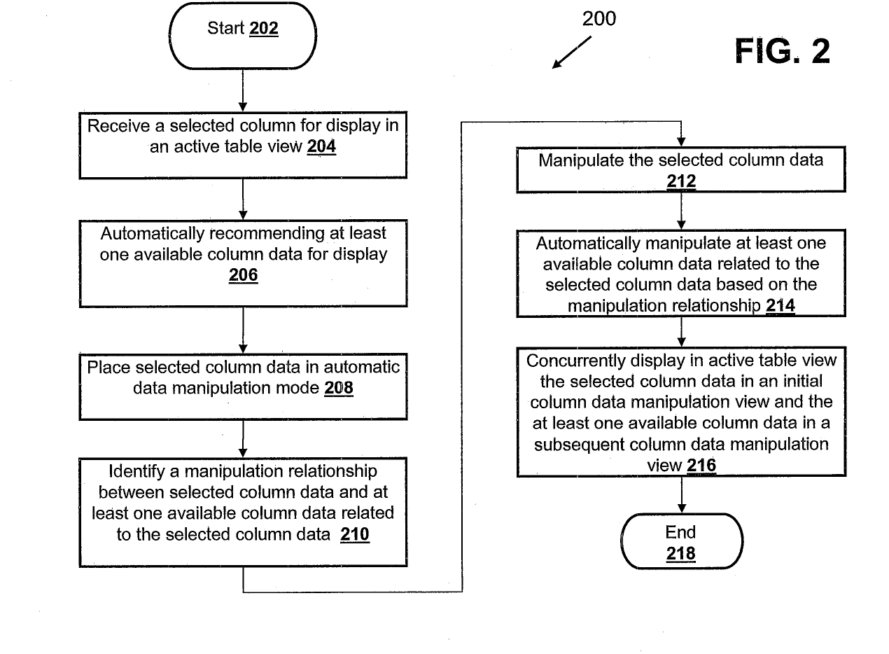

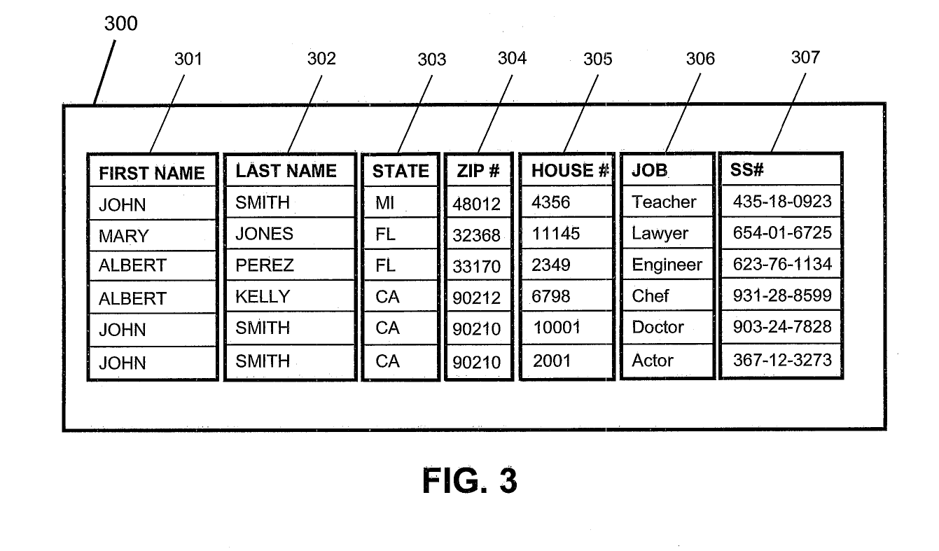

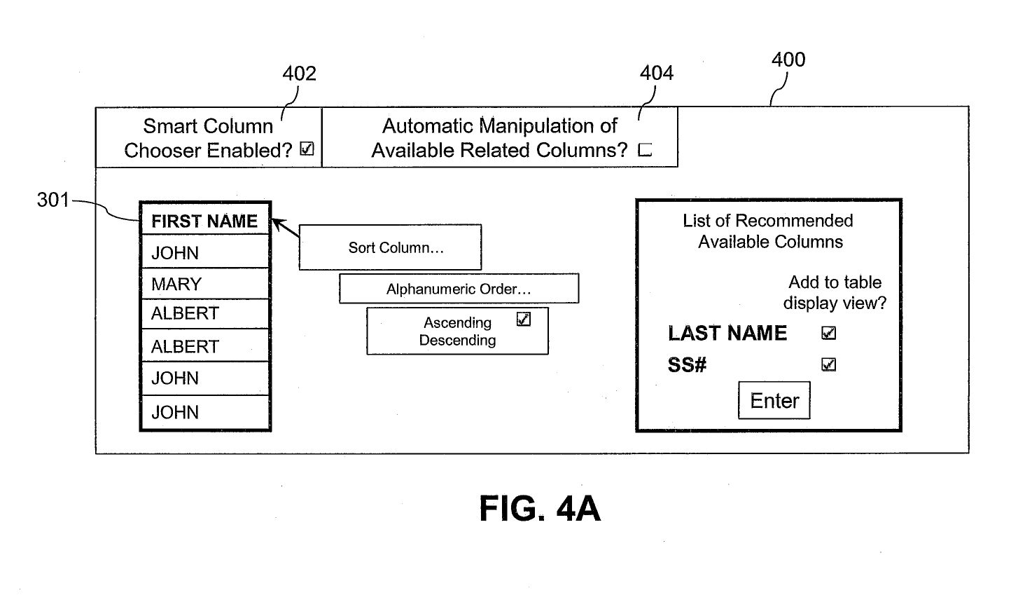

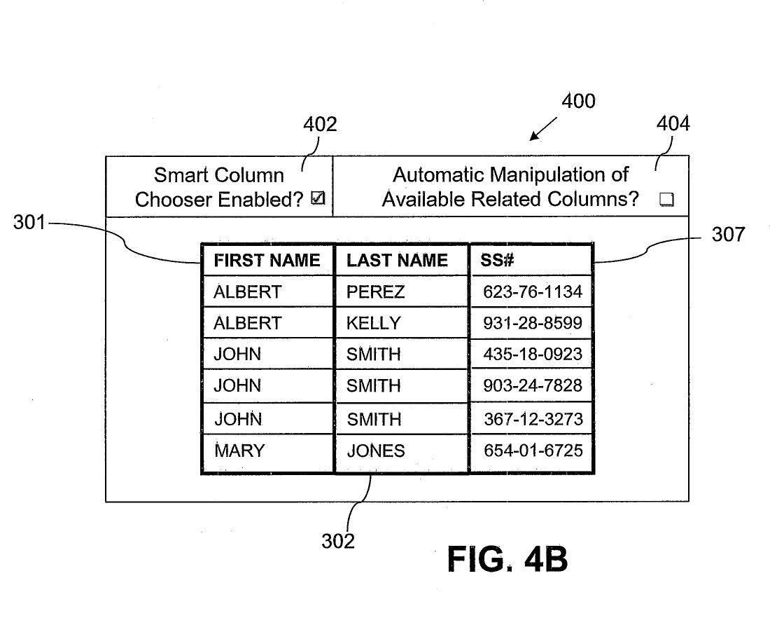

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with remote server 150. Application programs 144 in system memory 136 also include a Smart Column Ordering (SCO) Utility 148. SCO utility 148 performs the functions illustrated below in FIG. 2, and may include all logic, helper functions, databases and other resources depicted below in FIGS. 3A-4B. SCO utility 148 processes electronic signals from a multitude of sources, such as remote server 150 in network 128, as well as from other application programs 144, and/or database management system (DBMS) 147. As used herein, DBMS 147 is understood to here to cover any software or set of software programs that control the organization, storage, management, and retrieval of data in database 135. Such database information can be in the form of tabular data that can be accessed irrespective of the tabular data's mode of physical memory storage (e.g., row-store, column-store modes).

The data in database 135 is stored in one or more data containers. Each container contains records, and the data within each record is organized into one or more fields. In relational database systems, the data containers are referred to as tables, the records are referred to as rows, and the fields are referred to as columns. In object oriented databases, the data containers are referred to as object classes, the records are referred to as objects, and the fields are referred to as attributes. Other database architectures may use other terminology.

It is important to note that DBMSes that implement the present invention are not limited to any particular type of data container or database architecture. However, for the purpose of explanation, the examples and the terminology used herein shall be that typically associated with relational databases. Thus, the terms “table”, “row”, and “column” shall be used herein to refer respectively to the data container, record, and field.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

Referring now to FIG. 2, a high-level flow chart showing the method 200 of automating the selection and ordering of column data in a table for a user is presented. After initiator block 202, a selected column data is received for display in an active table view (block 204). As used herein, “selected column data” refers to data within a column that has been selected by a user and pulled into an active table view for display without any recommendation by SCO utility 148. The selected column data form part of an initial column in a table. If there are additional selected columns already in view, the selected column data is grouped with the additional selected columns containing data. When the selected column data is displayed: (i) as the initial column or (ii) as part of a group of columns (including the selected column(s) and any available columns that are pulled into display and grouped with the selected column(s)), the displayed view is referred to as an “active table view”.

From block 204, method 200 continues to block 206, where in response to receiving the selected column data, at least one available column data related to the selected column data is automatically recommended by SCO utility 148 for display in the active table view. As used herein, “available column data” refers to data within a column that is available to be grouped and displayed with the selected column data in the active table view. Although the data contained within an available column is capable of being displayed in the active table view, the present invention determines which available columns from a group of available columns are related to the selected column(s). The term “related”, in this context, refers to a strong relationship between the data values in one column and the corresponding data values contained in another column. When the available column(s) is/are identified as related to the selected column(s), the available column(s) can be: (i) automatically recommended to a user for display in the active table view, or according to another embodiment of the invention, (ii) automatically pulled into the active table view for display with the selected column(s).

The way in which SCO utility 148 determines which available columns are related to selected columns is based on a built-in knowledge of relationships between the different possible combination groupings of selected column(s) and the pool of available columns(s). In this regard, a degree of correlation between selected column data and one or more available column data is reflected and stored in predetermined metadata. The predetermined metadata identifies weighted relationships between data of a selected column (or selected column data) and data from one or more available columns (or available column data). Moreover, SCO utility 148 includes predetermined correlation thresholds, such that when the degree of correlation between the selected column data and one or more available column data exceeds a predetermined correlation threshold, the related available column data is automatically recommended for display and grouping with the selected column(s) in an active table view. In addition to providing automatic recommendations of available column(s) for display with selected column(s), SCO utility 148 automatically indicates to a user a relevance for displaying in the active table view the related available column(s) and selected column(s).

At block 208, the selected column data is placed in an automatic data manipulation mode. As used herein, an automatic data manipulation mode is defined as a mode in which the data of one or more available columns related to a selected column(s) are automatically manipulated (i.e., sorted and/or filtered) in response to a manipulation of data in the selected column(s). According to another embodiment of the invention, when the data manipulation mode is enabled, the available column(s) related to the selected column(s) is/are also automatically recommended for inclusion for display in the active table view in response to a manipulation of data in the selected column(s).

Continuing with method 200, in response to placing the selected column data in the automatic data manipulation mode, a manipulation relationship between the selected column data and the one or more available column data related to the data is identified (block 210). There are a variety of possible manipulation relationships that can be identified, which include, but are not limited to data sorting and data filtering. Data sorting refers to any process of arranging data values in a column in a particular sequence. Data filtering refers to any process that blocks access to data values in a column that meet a particular criterion.

Once a manipulation relationship is identified between the selected column data and the one or more available column data, the selected column data placed in the automatic data manipulation mode is manipulated (block 212). The manipulation of the selected column data in the automatic data manipulation mode includes an initial column action which is defined by an initial column data sort and/or an initial column data filter. For example, an initial column data sort can include, but is not limited to, a primary data sort. Once the selected column data has been manipulated, the available column(s) related to the selected column are automatically manipulated based on the identified manipulation relationship, as depicted in block 214. The manipulation of the available column(s) related to the selected column includes a subsequent column action which is defined by a subsequent column data sort and/or a subsequent column data filter.

Depending upon the number of available columns that are recommended to be grouped with a selected column that has undergone a primary data sort, there can be various data sort levels that can be undertaken as a subsequent data sort, such as a secondary data sort, a tertiary data sort, etc. The manner in which the available column data is automatically manipulated can either correspond or differ with how the selected column data is manipulated. The selected column and the available column(s) related to the selected column are then concurrently displayed in an active table view, as depicted in block 216. In this regard, the selected column that has been subjected to the initial column action is displayed in an initial column data manipulation view and the available column(s) related to the selected column is/are concurrently displayed in subsequent column data manipulation view(s). Method 200 ends at termination block 218.

With reference now to FIG. 3, an exemplary database containing data table 300 is shown. Such exemplary database would be typically found in database 135 (FIG. 1). Data table 300 includes columns 301-307 that are listed by their column header names (e.g., First Name 301, Last Name 302, State 303, Zip #304, House # 305, Job 306, and SS #307). The value contained at a particular row in column 301-307 of data table 300 corresponds to values in other columns 301-307 along the same row.

According to an embodiment of the present invention, a user manually selects one or more columns 301-307 from data table 300 for display in an active table view. When the one or more columns 301-307 are pulled into an active table view into an active table view for display without any recommendation by SCO utility 148, the displayed columns are then referred to as “selected column(s)”. In this regard, there are many ways a user can manually select columns for display in an active table view. In one implementation, a user interface displays two boxes (not shown): a selected column list box and an available column list box. The user selects which column header(s) from the available column list box to transfer to the selected column list box. Once the user has finished making his or her selection(s), the selected columns are displayed in an active table view.

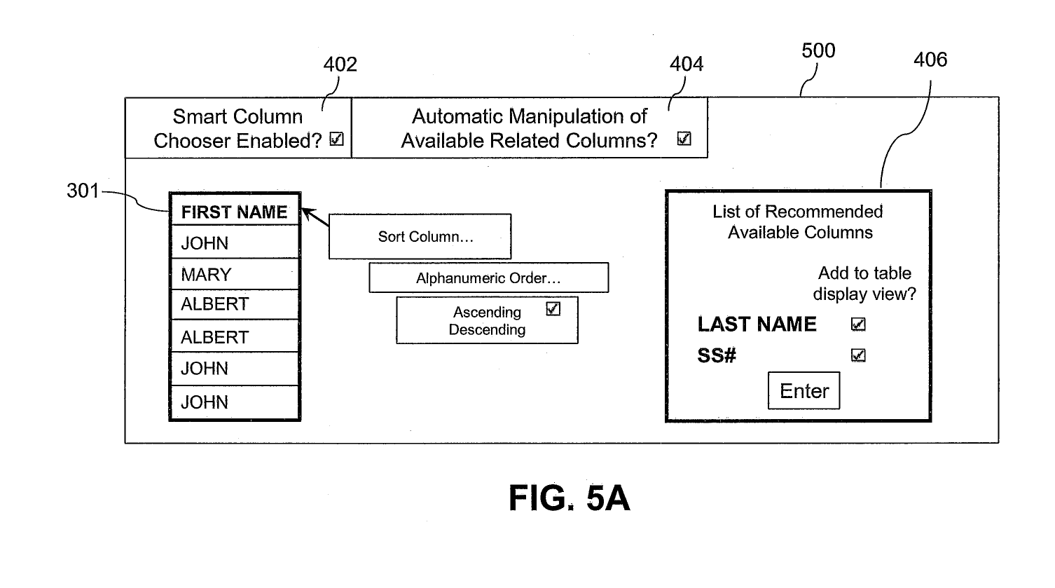

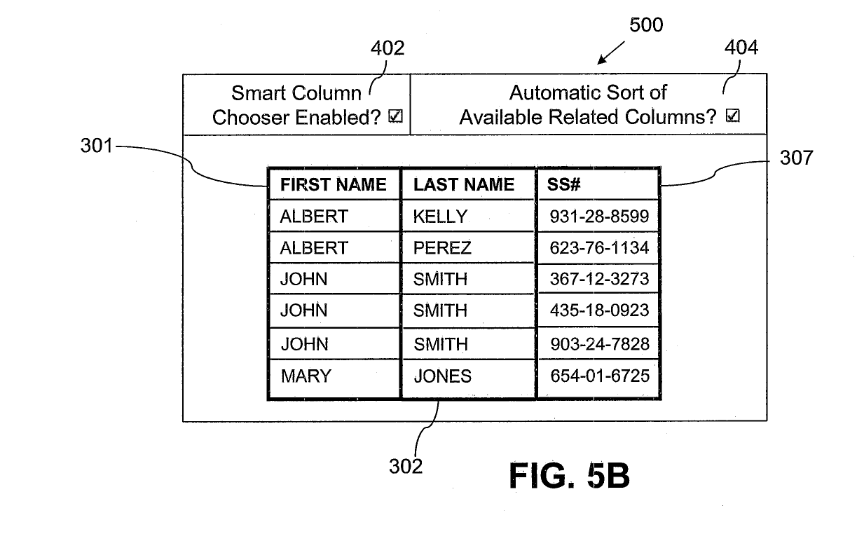

In FIG. 4A, an exemplary display screenshot 400 of selected column (e.g., column represented by First Name 301 (FIG. 3)) is shown. Display screenshot 400 includes two checkboxes: a Smart Column Chooser box 402 and an Automatic Sort of Available Columns box 404. Checkboxes 402 and 404 represent different graphical sub-implementations of SCO utility 148 (FIG. 1). For purposes of illustrating the functional differences between checkboxes 402 and 404, FIGS. 4A and 4B exemplify the situation when Smart Column Chooser box 402 is enabled and Automatic Sort of Available Columns box 404 is disabled. FIGS. 5A and 5B exemplify the situation when both Smart Column Chooser box 402 and Automatic Sort of Available Columns box 404 are enabled.

Referring now to FIG. 4A, when Smart Column Chooser box 402 is enabled (i.e., box is checked), SCO utility 148 will indicate to a user available column(s) that are “related” to the selected column. The degree of correlation that exists between a selected column and one or more available columns depends on a predetermined value stored as metadata. The predetermined value is assigned to a grouping of the selected column with one or more available columns. Such a predetermined value is arbitrarily set by the user. In another embodiment, the predetermined value can dynamically change based on the frequency of past manual user pairings of a selected column with one or more available columns.

Screenshot 400 shows a selected column (e.g., First Name column 301) on display. First Name column 301 is manually selected by the user from data table 300. Since Smart Column Chooser box 402 is enabled, available column list window 406 displays available columns (e.g., column headers for Last Name column 302 and SS #column 307) related to the selected column (e.g., First Name column 301). Moreover, First Name column 301 initially displays string data values that are not in alphanumeric order. When the data in First Name column 301 are sorted in ascending alphanumeric order with only the Smart Column Chooser box 402 enabled, the results are displayed according to what is shown in FIG. 4B.

Referring now to FIG. 4B, although the string data in First Name column 301 are sorted in ascending alphanumeric order, the available columns (e.g., Last Name column 302 and SS # column 307) related to the selected column and now grouped and displayed with the selected column do not undergo a secondary alphanumeric sort. This is due to the fact that Automatic Sort of Available Columns box 404 was not selected by the user. For example, selected column (i.e., First Name column 301) is sorted such that there are two consecutive values having the same string ‘Albert’ listed in ascending alphanumeric order, but available column, Last Name column 302, has not been sorted, having string value ‘Perez’ preceding string value ‘Kelly’.

When Automatic Sort of Available Columns box 404 is selected by the user, as is shown in FIGS. 5A and 5B, additional sorting of the available columns is automatically performed as compared to the displayed table in FIG. 4B. In FIG. 5A, for example, the user manually sorts First Name column 301 such that the string values are sorted in ascending alphanumeric order. Since Automatic Sort of Available Columns box 404 is selected by the user in this instance, the recommended available columns that are to be grouped and displayed in the active table view automatically undergo sorting before they are even selected by the user, as is subsequently depicted in screenshot 500 of FIG. 5B.

Thus, according to screenshot 500 of FIG. 5B, Last Name column 302 automatically undergoes a secondary sort, such that string value ‘Kelly’ precedes ‘Perez’ in ascending alphanumeric order. Moreover, additional sorting can take place. For example, in the selected First Name column sort, the ‘John’ string values are grouped alphanumerically. However, the string values in Last Name column 302, which correspond to the first name string value ‘John’ in First Name column 301, all contain the same string value ‘Smith’. As a result, a tertiary sort of the data in the SS# column 307 is undertaken, such that the social security numbers corresponding to the rows containing string values ‘John’ and ‘Smith’ are automatically sorted in ascending alphanumeric order.

The automatic manipulation of related available column data (e.g., the data sorting undertaken in the example shown in FIGS. 5A and 5B) is based on the identification of a manipulation relationship between the data that is manipulated within the selected column and the data that is manipulated within one or more available columns related to the selected column data. The available columns related to the selected column are then displayed in a column data manipulation view. If the manipulation occurs to a selected column, the resulting view of the selected column is referred to as an initial column data manipulation view. If the manipulation is performed on an available column that is related to the selected column, the resulting view of the available column is referred to as a subsequent column data manipulation view. The subsequent column data manipulation view can include different levels of sorting and/filtering, such as a secondary sort, tertiary sort, and the like.

Moreover, the physical positioning of available columns relative to the selected column(s) within an active table view is affected by the degree of correlation between the selected column data and the available column data that is pulled into the active table view. For example, FIGS. 4B and 5B show how Last Name column 302 is positioned adjacent and to the right of First Name column 301, with SS# column 307 being positioned at the far right of the active table. Such exemplary positioning indicates that the degree of correlation between the First Name column 301 and Last Name column 302 is greater in correlation as compared to the degree of correlation between the First Name column 301 and SS# column 307. However, it should be appreciated that the degree of correlation between columns can vary depending upon the predetermined value that is stored as metadata. In addition, the idea of grouping available columns related to a selected column in an active table view can be also extended in reverse to circumstances when a selected column is removed. Thus, when a selected column that has prompted the additional grouping of an available column(s) is removed from the active table view, the available column(s) related to the removed selected column is/are also removed from the active table view.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for automating the selection and ordering of column data in a table for a user, the method comprising:
receiving a selected column data for display in an active table view;
in response to receiving said selected column data, automatically recommending for display in said active table view at least one available column data related to said selected column data;
placing said selected column data in an automatic data manipulation mode;
in response to placing said selected column data in said automatic data manipulation mode, identifying a manipulation relationship between said selected column data and said at least one available column data related to said selected column data;
manipulating said selected column data in said automatic data manipulation mode, wherein said manipulating step of said selected column data is an initial column action including at least one of an initial column data sort or an initial column data filter;
responsive to said initial column action of said selected column data, automatically manipulating said at least one available column data related to said selected column data, wherein said automatic manipulating step of said at least one available column data is a subsequent column action including at least one of a subsequent column data sort or a subsequent column data filter; and
concurrently displaying in said active table view said selected column data in an initial column data manipulation view and said at least one available column data related to said selected column data in a subsequent column data manipulation view.

2. The method of claim 1, further comprising:
physically positioning within said active table view said at least one available column data in a first position relative to a second position of said selected column data, wherein said physical positioning is based upon a degree of correlation between said selected column data and said at least one available column data.

3. The method of claim 2, wherein said degree of correlation between said selected column data and said at least one available column data is based on predetermined metadata identifying at least one weighted relationship between said selected column data and at least one available column data.

4. The method of claim 1, further comprising:
removing said at least one available column data from said active table view when said selected column data is removed from said active table view.

5. The method of claim 1, wherein the available column data related to said selected column data for display in said active table view is manipulated in the same manner as said manipulation of said selected column data.

6. The method of claim 1, further comprising:
automatically indicating to said user a relevance for displaying in said active table view said selected column data with said at least one available column data.

7. A computer program product for automating the selection and ordering of column data in a table for a user comprising: a computer storage medium; and program code on the computer storage medium that when executed provides the functions of:
receiving a selected column data for display in an active table view;
in response to receiving said selected column data, automatically recommending for display in said active table view at least one available column data related to said selected column data;
placing said selected column data in an automatic data manipulation mode;
in response to placing said selected column data in said automatic data manipulation mode, identifying a manipulation relationship between said selected column data and said at least one available column data related to said selected column data;
manipulating said selected column data in said automatic data manipulation mode, wherein said manipulating step of said selected column data is an initial column action including at least one of an initial column data sort or an initial column data filter;
responsive to said selected column action of said selected column data, automatically manipulating said at least one available column data related to said selected column data, wherein said automatic manipulating step of said at least one available column data is a subsequent column action including at least one of a subsequent column data sort or a subsequent column data filter; and
concurrently displaying in said active table view said selected column data in an initial column data manipulation view and said at least one available column data related to said selected column data in a subsequent column data manipulation view.

8. The computer program product of claim 7, wherein the program code further provides the function of:
physically positioning within said active table view said at least one available column data in a first position relative to a second position of said selected column data, wherein said physical positioning is based upon a degree of correlation between said selected column data and said at least one available column data.

9. The computer program product of claim 8, wherein said degree of correlation between said selected column data and said at least one available column data is based on predetermined metadata identifying at least one weighted relationship between said selected column data and at least one available column data.

10. The computer program product of claim 7, wherein the program code further provides the function of:
removing said at least one available column data from said active table view when said selected column data is removed from said active table view.

11. The computer program product of claim 7, wherein the available column data related to said selected column data for display in said active table view is manipulated in the same manner as said manipulation of said selected column data.

12. The computer program product of claim 7, wherein the program code further provides the function of:
automatically indicating to said user a relevance for displaying in said active table view said selected column data with said at least one available column data.

13. A computer system comprising:
a processor unit;
a memory coupled to the processor unit; and
a Smart Column Ordering (SCO) utility executing on the processor unit and having executable code for:
receiving a selected column data for display in an active table view;
in response to receiving said selected column data, automatically recommending for display in said active table view at least one available column data related to said selected column data;
placing said selected column data in an automatic data manipulation mode;
in response to placing said selected column data in said automatic data manipulation mode, identifying a manipulation relationship between said selected column data and said at least one available column data related to said selected column data;
manipulating said selected column data in said automatic data manipulation mode, wherein said manipulating step of said selected column data is an initial column action including at least one of an initial column data sort or an initial column data filter;
responsive to said selected column action of said selected column data, automatically manipulating said at least one available column data related to said selected column data, wherein said automatic manipulating step of said at least one available column data is a subsequent column action including at least one of a subsequent column data sort or a subsequent column data filter; and
concurrently displaying in said active table view said selected column data in an initial column data manipulation view and said at least one available column data related to said selected column data in a subsequent column data manipulation view.

14. The computer system of claim 13, the SCO utility further having executable code for:
physically positioning within said active table view said at least one available column data in a first position relative to a second position of said selected column data, wherein said physical positioning is based upon a degree of correlation between said selected column data and said at least one available column data.

15. The computer system of claim 14, wherein said degree of correlation between said selected column data and said at least one available column data is based on predetermined metadata identifying at least one weighted relationship between said selected column data and at least one available column data.

16. The computer system of claim 13, the SCO utility further having executable code for:
removing said at least one available column data from said active table view when said selected column data is removed from said active table view.

17. The computer system of claim 13, wherein the available column data related to said selected column data for display in said active table view is manipulated in the same manner as said manipulation of said selected column data.

18. The computer system of claim 13, the SCO utility further having executable code for:
automatically indicating to said user a relevance for displaying in said active table view said selected column data with said at least one available column data.
